(19) United States
(12) Patent Application Publication
(10) Pub. No.: US 2009/0252279 A1
(43) Pub. Date: Oct. 8, 2009

(54) Fuel Pellet for a Nuclear Reactor and Method for Producing Fuel Pellet

(75) Inventors: Wolfgang Dorr, Herzogenaurach (DE); Volker Lansmann, Weisendorf (DE)

Correspondence Address: LERNER GREENBERG STEMER LLP, P O BOX 2480, HOLLYWOOD, FL, 33022-2480, US

(73) Assignee: AREVA NP GMBH, Erlangen (DE)

(21) Appl. No.: 12/333,723

(22) Filed: Dec. 12, 2008

Related U.S. Application Data
(62) Division of application No. 11/113,746, filed on Apr. 25, 2005.
Application No. 11/113,746 is a continuation of application No. PCT/EP2003/011594, filed on Oct. 20, 2003.

(30) Foreign Application Priority Data
Oct. 23, 2002 (DE) 102 49 355.3

(51) Int. Cl. G21C 3/00

(52) U.S. Cl. 376/414

(57) ABSTRACT

A fuel pellet for a nuclear reactor contains a matrix made of an oxidic nuclear fuel and a metallic phase that is deposited within or between the fuel grains and is preferably aligned in a radial direction relative to the coating surface of the pellet. A method for producing the fuel pellet includes forming slugs containing a precursor of the metallic phase, which has a melting point lying below the sintering temperature and can be transformed into the metallic phase in sintering conditions, in addition to the oxidic nuclear fuel and other optional additives. The slugs are then sintered. The slugs are heated up so quickly that at least one portion of the precursor is liquefied before being completely transformed into the metallic phase.

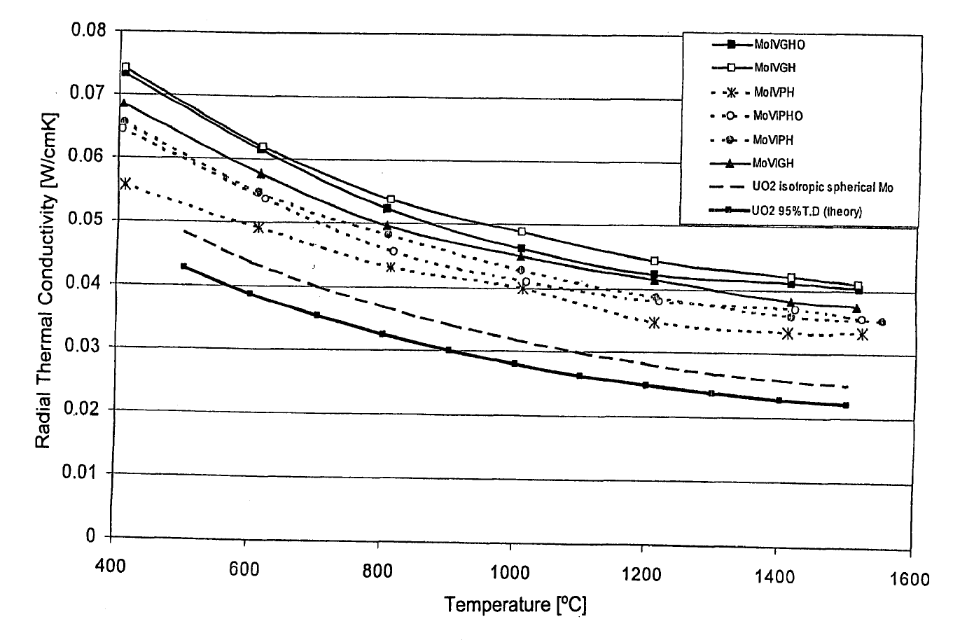

### CROSS-REFERENCE TO RELATED APPLICATION

This is a divisional application of application Ser. No. 11/113,746, filed Apr. 25, 2005; which was a continuing application, under 35 U.S.C. §120, of International application PCT/EP2003/011594, filed Oct. 20, 2003; the application also claims the priority, under 35 U.S.C. §119, of German patent application No. DE 102 49 355.3, filed Oct. 23, 2002; the prior applications are herewith incorporated by reference in their entirety.

### BACKGROUND OF THE INVENTION

### Field of the Invention

The invention relates to a fuel pellet for light water reactors and to a process for producing the fuel pellets. In a light water reactor, whether this is a pressurized water reactor or a boiling water reactor, the fuel pellets are disposed in cladding tubes. Operation of the reactor forms fission gases, which are initially retained in the fuel pellets but subsequently diffuse via the outer surface of the pellets into the gap between the pellets and the cladding tube. Therefore, the cladding tubes have to be sealed, so that the fission gases cannot reach the outside. It is a goal to increase the rod power and the burn up with a view to optimizing the economics of fuel assemblies. However, this causes increased amounts of fission gases to be released, which can have the effect of restricting the burn up. It is known that the retention capacity for fission gases is increased if the pellets have sintered grains that are as large as possible. To achieve this, it is possible for a substance that promotes grain growth, such as for example Fe₂O₃, Cr₂O₃, TiO₂, Nb₂O₅, Al₂O₃ etc., to be added to the starting materials. The release of fission gases can be further reduced using pellets that contain metallic precipitations. The metallic precipitations have a significantly higher thermal conductivity than the oxidic matrix of the pellets. The resultant improvement in the dissipation of heat leads to a reduction in the temperature gradient between the core of the pellet and its outer surface and lowers the central temperature of the fuel pellet. A low central temperature reduces the mobility of the fission gases in the fuel and thereby lowers the rate at which fission gases are released. The lower overall heat content of pellets with an increased thermal conductivity improves the fuel assembly performance under accident conditions (LOCA=Loss of coolant accident; RIA=reactivity initiated accident) by lengthening the time before the fuel assembly is destroyed. A lower central temperature with otherwise identical fuel properties also reduces what is known as the hour-glass effect, which has an adverse effect on the pellet cladding interaction (PCI) properties of a pellet.

European Patent EP 0 701 734 B1 (corresponding to U.S. Pat. No. 5,999,585 A1) discloses fuel pellets with a metal dispersed in the oxidic matrix. The metal is supposed to serve to trap oxygen formed during nuclear fission.

### SUMMARY OF THE INVENTION

It is accordingly an object of the invention to provide a fuel pellet for a nuclear reactor and a method for producing the fuel pellet which overcomes the above-mentioned disadvantages of the prior art devices and methods of this general type, which has an increased retention capacity for fission gases.

With the foregoing and other objects in view there is provided, in accordance with the invention, a fuel pellet for a nuclear reactor. The fuel pellet contains a matrix of an oxidic nuclear fuel having fuel grains and a metallic phase deposited in or between the fuel grains. The metallic phase is oriented radially toward a lateral surface of the fuel pellet.

The object is achieved, with regard to the fuel pellet by virtue of the fact that a preferably radially oriented metallic phase is precipitated or present in the oxidic matrix. In other words, the precipitations preferentially extend in the direction of the heat flux from the center of the pellet toward its outer surface, and to a lesser extent in the axial direction, in which no heat exchange takes place on account of the absence of a temperature gradient. The result of this is that for the same metal content, with the anisotropy present in accordance with the invention the dissipation of heat from the pellet is greater than with an isotropic distribution, i.e. a thermal conductivity in the radial direction comparable to that of a pellet according to the invention can be achieved in pellets with an isotropic distribution of the metal precipitations, but only by an increased metal content. However, this would mean that a pellet of this type would contain a correspondingly reduced quantity of fissile material and would therefore have a lower burn up.

A preferred fuel pellet contains a metallic phase amounting to 0.1 to 6% by weight, preferably more than 2% by weight. In principle, the idea according to the invention can be applied to any desired nuclear fuels, for example based on UO_{2±x}, UPuO_{2±x}, UGdO_{2±x} or UThO_{2±x}. The metallic phase used is preferably a metal such as Ti, Cr, Nb, Mo, Wo and/or an alloy based on at least one of these metals.

With regard to a process for producing a fuel pellet, the invention is achieved, by producing green slugs which, in addition to the oxidic nuclear fuel and any further additives, also contain a precursor of the metallic phase, which has a melting point below the sintering temperature and can be converted into the metallic phase under sintering conditions. The green slugs are sintered in such a way that the heating to the sintering temperature takes place sufficiently quickly for at least some of the precursor to have melted before it has been completely converted into the metallic phase, which is solid at the prevailing temperatures. A procedure of this type produces pellets in which a metallic phase is deposited in intragranular and/or intergranular form and is preferentially radially oriented. This anisotropy of the metallic phase is produced in the following way: the starting mixture in powder or granule form is compressed in the conventional way in a cylindrical mold, into which a ram is pressed, i.e. the starting mixture is compressed practically only in the axial direction. Accordingly, cavities and pores that are present therein are at least to a certain extent compressed in the axial direction, whereas their original extent is retained or increased in the radial direction. Pellets produced in this way therefore inherently contain pores or cavities that preferentially extend in the radial direction. The invention is now based on the idea of filling these inherently radially oriented cavities with a substantially cohesive metallic phase, and thereby increasing the thermal conductivity of the pellet in the radial direction. The molten phase that originates from a particle of the precursor can, as it were, flow into cavities in the pellet and combine with the molten phase of adjacent precursor particles to form larger cohesive regions. In contrast, the pellet which is known from European patent EP 0 701 734 B1 aims to produce a distribution which is as uniform as possible of a large number of small metal particles with the maximum possible active surface area, in order to allow reaction with the fission gas oxygen.

In a preferred variant of the process, at least the nuclear fuel is granulated, and the precursor of the metallic phase is only added after the granulation step. The procedure allows the anisotropy of the metallic phase in the radial direction to be increased further. Particles of the starting powder are known to be agglomerated in a granule grain. The cohesion of the powder particles in a granule grain is not now sufficient for it to be able to withstand the pressure when a green slug is being pressed. Therefore, the granule grains are compressed during the pressing operation and thereby flattened. Accordingly, a greater proportion of the grain boundaries between the granule grains run in the radial direction than in the axial direction after the pressing operation. On account of the fact that the precursor of the metallic phase is added not to the fuel powder, but rather to the granules produced therefrom, the granule grains are, as it were, surrounded by the precursor. Accordingly, the precursor of the metallic phase, after the pressing operation, is disposed in the grain boundaries, which run predominantly in the radial direction. During the melting of the precursor during the heating operation, cohesive metallic regions that increase the thermal conductivity in the radial direction are formed in the grain boundaries.

Other features which are considered as characteristic for the invention are set forth in the appended claims.

Although the invention is illustrated and described herein as embodied in a fuel pellet for a nuclear reactor and a method for producing the fuel pellet, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The single FIGURE of the drawing is graph showing measurement results carried out on pellets according to the invention.

### DETAILED DESCRIPTION OF THE INVENTION

In a first embodiment for a fuel pellet according to the invention, the precursor used is a metal oxide, a melting point of which is below the sintering temperature, with sintering being carried out under reducing conditions and the heating being carried out sufficiently quickly for at least some of the metal oxide to melt before it is reduced to form metal. Examples of metal oxides that have such properties include MoO₂ and MoO₃.

In a second embodiment, a metal oxide is likewise used as the precursor, but sintering is carried out initially at a relatively low pre-sintering temperature and under oxidizing conditions, until at least some of the metal oxide has melted, after which reducing conditions and a higher temperature, i.e. at least toward the end of sintering the required sintering temperature, are applied. Although this process entails greater technical outlay, on account of involving two stages, it has the advantage that not just some but all of the quantity of metal oxide added can be melted before the reduction to the metal commences. It is in this way possible to produce particularly large cohesive and radially oriented metallic regions in a pellet, in particular if the precursor is added to the granules. Suitable metal oxides in this case are MoO₂ and MoO₃. When using these oxides, it is expedient to maintain a pre sintering temperature of 800 to 1300° C. At temperatures of this level, MoO₃, which has a melting point of 795° C., is converted into the molten form. MoO₂ disproportionates to form metallic molybdenum and MoO₃ when it is heated. MoO₃ is liquefied at the prevailing temperatures.

Whereas in the previous variants of the method a precursor of the metallic phase is converted into the metal during sintering, in a further process variant, a fundamentally different route is taken. A metal powder containing nonspherical, i.e. elongate or acicular or platelet-like particles is added to the starting mixture. The particles are initially in an unordered arrangement. The pressing of the mixture and the associated compression of the material in the axial direction causes particles that have hitherto been more axially oriented to adopt a radial orientation. The green slugs obtained in this way can be sintered in a conventional way to form finished pellets.

### EXAMPLE 1

UO₂ 78.85% by weight

U₃O₈ 15.36% by weight

MoO₂ 5.79% by weight

### EXAMPLE 2

UO₂ 78.28% by weight

U₃O₈ 15.25% by weight

MoO₂ 6.47% by weight

### EXAMPLE 3

UO₂ 92.2% by weight

U₃O₈ 5.16% by weight

MoO₂ 2.65% by weight

First, a homogenized uranium oxide starting mixture in accordance with Example 1, 2 or 3 is produced. This is followed by production of the granules, in which the starting mixture is consolidated and then pressed through a screen with a screen width of 14 mesh for example. This results in granule grains with a mean diameter of approximately 1 mm. Then, MoO₂ or MoO₃ is added to the granules. It is also conceivable for the molybdenum oxide to be admixed with the fuel powder. If necessary, pressing aids and/or dopants can also be admixed to the base mixture before or after the granulation step. The granules obtained are in each case pressed to form green slugs, which are then sintered.

The sintering can now be carried out in two different variants:

### Variant 1:

The green slugs are sintered in a sintering furnace at temperatures around approximately 1600°-1850° C. under reducing conditions. The heating is controlled in such a way that the melting point of MoO₃ (795° C.) is reached as quickly as possible, so that the (non liquefiable) fraction that is reduced to molybdenum remains as low as possible. Good results are obtained with heating rates of from 10 to 20° C./min. The reducing conditions are ensured by an H₂ containing atmosphere. It is also possible for further gases, such as CO₂, H₂O (steam), N₂ or argon, individually or in any desired mixture, to be added to the H₂ atmosphere in order to set a desired oxygen potential. In the case of green slugs that contain MoO₂, disproportionation into metallic molybdenum and MoO₃ takes place first.

### Process Variant 2:

In this case, the green slugs are sintered in a two-stage process. First, the green slugs are treated at a

pre-sintering temperature of approximately 80° to 1300° C. in an oxidizing atmosphere (for example technical grade CO₂). Since there is now no risk of the molybdenum oxide being reduced, the heat treatment can be carried out until all the molybdenum oxide has melted. Then, reducing conditions are set. By way of example, a sintering furnace that has different zones each containing different atmospheres can be used for this purpose. Depending on the prior procedure, the green slugs are then fully sintered at a sintering temperature of between 1100°-1850° C. In the reducing atmosphere, uranium oxide that has been partially oxidized in the first stage of the process, is reduced again to a sufficient extent for a stoichiometric U/O ratio of 1/2 to be set.

The FIGURE of the drawing shows the results of measurements, which were carried out on pellets with a composition corresponding to Examples 1 and 2 above. The quantity of molybdenum oxide contained in the starting mixtures of 5.8% and 6.5% corresponds to a molybdenum content of 4.4% in the pellets.

In the FIGURE:

MoIV/MoVI denotes the starting mixture containing MoO₂ or MoO₃, respectively,

G/P denotes the addition of the molybdenum oxide to the granules or to the powder;

H denotes sintering under hydrogen; and

HO denotes sintering under hydrogen/CO₂.

It is clear from the FIGURE that all the pellets have a thermal conductivity that is above the calculated thermal conductivity of UO₂ pellets with isotropically distributed, spherical MO precipitations (lower dashed curve). It can be seen from the FIGURE that adding the molybdenum oxide to the granules gives better results than adding the molybdenum oxide to the powder. The influence of the sintering atmosphere on the thermal conductivity is less pronounced.

This application claims the priority, under 35 U.S.C. § 119, of German patent application No. 102 49 355.3, filed Oct. 23, 2002; the entire disclosure of the prior application is herewith incorporated by reference.

1. A process for producing fuel pellets, which comprises the steps of:
producing green slugs by axial compression of starting materials including an oxidic nuclear fuel and a precursor of a metallic phase, the precursor having a melting point below a sintering temperature and can be converted into the metallic phase under sintering conditions; and
sintering the green slugs, with the green slugs being heated at a rate such that at least some of the precursor is liquefied before being completely converted into the metallic phase, with a liquefied precursor filling radially oriented pores or cavities in an oxidic matrix formed as a result of the axial compression.

2. The process according to claim 1, which further comprises:
granulating the oxidic nuclear fuel into granules; and
admixing the precursor of the metallic phase with the granules.

3. The process according to claim 1, which further comprises:
using a metal oxide as the precursor;
carrying out the sintering under reducing conditions; and
carrying out the heating sufficiently quickly for at least some of the metal oxide to melt before it is reduced to form metal.

4. The process according to claim 3, which further comprises providing MoO₂ and/or MoO₃ as the metal oxide.

5. The process according to claim 4, which further comprises carrying out the heating at a rate of from 10 to 20° C./min in a temperature range from 300° to 1100° C.

6. The process according to claim 5, which further comprises carrying out the heating in a temperature range from 400° to 1000° C.

7. A process for producing fuel pellets, which comprises the steps of:
producing green slugs by axial compression of starting materials including an oxidic nuclear fuel and a metal oxide resulting in an oxidic matrix;
sintering the green slugs first at a relatively low
pre-sintering temperature and under oxidizing conditions until at least some of the metal oxide has melted and fills pores or cavities in the oxidic matrix being radially oriented as a result of the axial compression; and
applying reducing conditions and temperatures of between 1000° and 1850° C.

8. The process according to claim 7, which further comprises providing MoO₂ and/or MoO₃ as the metal oxide.

9. The process according to claim 7, which comprises setting the pre-sintering temperature to from 800 to 1300° C.

10. The process according to claim 7, which further comprises:
granulating the oxidic nuclear fuel into granules; and
admixing the metal oxide with the granules.

11. The process according to claim 7, which further comprises during the axial compression step, forming
the pores or the cavities in the oxidic matrix to be radially oriented.

12. A process for producing fuel pellets, which comprises the steps of:
admixing nonspherical metal particles with an oxidic fuel powder resulting in a starting mixture;
pressing the starting mixture for forming green slugs with the nonspherical metal particles oriented radially toward a lateral surface of a fuel pellet; and
sintering the green slugs.

13. The process according to claim 1, which further comprises providing mixtures containing 70 to 95% by weight of UO₂ and 4 to 25% by weight of U₃O₈ to produce the green slugs.

14. The process according to claim 7, which further comprises providing mixtures containing 70 to 95% by weight of UO₂ and 4 to 25% by weight of U₃O₈ to produce the green slugs.

15. The process according to claim 1, which further comprises adding a substance for promoting grain growth.

16. The process according to claim 7, which further comprises adding a substance for promoting grain growth.
